(19) United States
(12) Patent Application Publication
(10) Pub. No.: US 2015/0227579 A1
(43) Pub. Date: Aug. 13, 2015

(54) SYSTEM AND METHOD FOR DETERMINING INTENTS USING SOCIAL MEDIA DATA

(71) Applicant: TLL, LLC, Santa Monica, CA (US)

(72) Inventors: Alejandro Cantarero, Santa Monica, CA (US); Benjamin Feinman, Venice, CA (US); Nathan Haugo, San Francisco, CA (US)

(73) Assignee: TLL, LLC, Santa Monica, CA (US)

(21) Appl. No.: 14/179,478

(22) Filed: Feb. 12, 2014

(51) Int. Cl. G06F 17/30

(52) U.S. Cl. CPC G06F 17/30401; G06F 17/30412; G06F 17/30867; G06F 17/3053

(57) ABSTRACT

A system and method for determining intent of posters to a social media site for a predetermined topic through the analysis of the poster's posts. The system and method also allows for extrapolation and predictive analysis of the intent data determinations to provide insight into the views and intent of the general populace regarding a selected topic.

### BACKGROUND

In recent times, the internet has become an extremely useful tool for users or entities to conduct research on a particular subject or topic of interest. In one instance, a corporation or an individual may want to use the internet to do market research on a particular product or service. An important aspect of market research is to delve into the likes and dislikes of consumers or potential consumers for that particular object. Social media has provided a platform for deriving such insights. Social media is a window to the likes, dislikes, trends, and general sentiment of the populace. Companies have derived information from social media in several ways, but almost always required a level of human interaction. For example, a news reporter or journalist may frequently access one or more social media websites searching for hot topics or trends.

In some cases simple automated analysis has been applied to social media, such as tools that track hashtags. However, deriving meaningful or deeper insights and context from a hashtag still requires human analysis. For example, knowing that a hashtag has been posted 1000 times in the last ten minutes only provides a limited amount of insight into the intent of the poster. Furthermore, this type of analysis is limited to the portions of social media data that have been provided with a level of structure, such as hashtags, and ignores the majority of social media data, which is unstructured text. This occurs because computers are not equipped to deal with unstructured data. Additionally, it is difficult for a computer to process the sheer amount of data generated from the social media.

Thus a need exists for a method and system for deriving relevant and deeper insights from social media data through computer automation. The present invention satisfies this and other needs.

### SUMMARY OF THE INVENTION

In its most general aspect, the invention includes a system and method for processing and analyzing text from the internet including social media data. The system disclosed is capable of ingesting web based data including, but not limited to webpages, forums, social media website, and the like. In one aspect, the invention includes a system and method for consuming internet data and processing the data with a natural language processing engine to predict or identify an identity, intent, sentiment, subject, or geographical data. In another aspect, the invention includes a system that performs clustering algorithms on data extracted from the internet to provide additional context to the data. The additional context to the data may allow the invention or other systems to use the context for ad targeting or system alerts.

In another aspect, the present invention includes a system and method of conducting statistical analysis on data processed by a natural language processor and provides a visual and/or graphical depiction of the statistical analysis.

In yet another aspect, the present invention includes a system and method of performing clustering algorithms on data extracted from the internet, including social media, for ad targeting. In one aspect, a target or group of targets for a particular product or service may be identified through correlations between social media data and demographic data. In another a target or group of targets for a particular product or service may be identified through correlations between social media and any metrics used by a customer to measure ROI such as box office results, web page statistics, ad revenue, ad click through rates, television ratings, and the like.

In yet another aspect, the present invention includes a system and method of performing clustering algorithms on data extracted from the internet to provide additional context to the data and then provide that context to additional systems such as ad targeting or alert systems.

In another aspect, the present invention includes a system and method for identifying key words in social media posts that are related to a particular subject or topic.

In yet another aspect, the present invention includes a system and method for establishing a database of internet users or presences and predicting the individual's intent regarding one or more products and/or services. In one aspect, the individual's intent in the database may be updated and changed over time based on the individual's actions.

In yet another aspect, the present invention may track social media postings for reposts, quotes, videos, trailers, articles, reviews, commentary and other related materials for determining popular reasons for an intent prediction for a poster.

In yet another aspect, the invention includes a computer implemented method for determining intent of a social media poster comprising: receiving social media post data; separating text data from the social media post data; identifying a username from the social media post data; creating a profile in a database for the username; determining a predetermined topic the post is related to; processing the text data through a natural language processing engine; and determining an intent level based on output of the natural language processing engine. In some embodiments the method includes identifying predetermined keywords within the text data. In some embodiments the method includes updating an intent state in the profile. In some embodiments the method includes determining a predicted action for an author of the social media post data. In some embodiments the method includes attaching a confidence level to the predicted action based on a past prediction. In some embodiments the method includes, receiving an additional social media post data from the author indicating an action and confirming the predicted action based on the additional social media post data. In some embodiments the method includes targeting an ad to the author based on the intent level.

In yet another aspect, the present invention includes a computer implemented method for establishing a new keyword for a topic comprising: having a keyword threshold; receiving a plurality of individual posts as social media post data; identifying a noun or noun phrase in the plurality of individual posts; identifying a predetermined keyword in the plurality of posts; determining a number of posts in the plurality of posts that have both the noun or noun phrase and predetermined keyword; and identifying the noun or noun phrase as a keyword when the number of posts reaches the keyword threshold.

In yet another aspect the present invention includes a computer implemented method for monitoring clusters of content in a data stream that checks the size, volume of sharing, and acceleration of the cluster to determine if this is an important trending cluster. If the cluster of content is flagged as being important, a new data stream is created to filter around multiple keywords, hashtags, usernames, etc. that were detected as import via the NLP engine in the cluster of content.

In yet another aspect, the present invention includes a computer implemented method of targeting ads for a product comprising: receiving social media post data; identifying a poster; processing the received social media post data with a natural language processing engine and assigning an intent level to the poster based on the natural language processing engine's analysis; and discriminating ads transmitted to the poster based on the assigned intent level.

In another aspect, the invention includes a system comprising: one or more processors; logic encoded in one or more non-transitory computer-readable media that, when executed by the one or more processors, is operable to: receive social media post data; separate text data from the social media post data; identify a account from the social media post data; create a profile in a database for the account; determine a predetermined topic the post is related to; use a natural language processing engine to process the text; and determine an intent level based on output of the natural language processing engine.

In yet another aspect, the invention includes a system comprising: one or more processors; logic encoded in one or more non-transitory computer-readable media that, when executed by the one or more processors, is operable to: receive a plurality of individual posts as social media post data; identify a noun or noun phrase in the plurality of individual posts; identify a predetermined keyword in the plurality of posts; determine a number of posts in the plurality of posts that have both the noun or noun phrase and predetermined keyword; and identify the noun or noun phrase as a keyword when the number of posts reaches a keyword threshold.

In yet another aspect, the invention includes a system comprising: one or more processors; logic encoded in one or more non-transitory computer-readable media that, when executed by the one or more processors, is operable to: receive a plurality of individual posts as social media post data; identify the noun or noun phrases as a keyword; identify a predetermined keyword in the plurality of posts; determine a number of posts in the plurality of posts that have both the noun or noun phrase and predetermined keyword; and identify the noun or noun phrase as a keyword when the number of posts reaches a keyword threshold.

In still another aspect, the invention includes a system comprising: one or more processors; logic encoded in one or more non-transitory computer-readable media that, when executed by the one or more processors, is operable to: receive social media post data; identify a poster; and run the received social media post data through a natural language processing engine and assigning an intent level to the poster based on the natural language processing engine's analysis.

In yet another aspect, the invention includes a computer implemented method for dynamically creating a new topic by clustering social media posts related to a first topic, identifying a cluster with an accelerating share count, identifying a key word in the cluster, and creating the new topic using the identified key word. In some embodiments the method includes determining a first word use frequency for every word in all the social media posts and ranking words based on the first word use frequency. In some embodiments the method includes determining a use frequency for a word group in all the social media posts. In some embodiments the method includes determining a second word use frequency for every word in the social media post within a limited time frame and ranking words based on the first word use frequency and second word use frequency. In some embodiments the method includes matching an individual post to a highest ranked word used in the individual post. In some embodiments the ranking of a word is inversely related to the first word use frequency. In some embodiments identifying a cluster with an accelerating share count is determined by receiving a first plurality of posts within a first limited time frame, receiving a second plurality of posts within a second limited time frame, calculating a first number of individual posts related to the cluster in the first plurality of posts within a first limited time frame, calculating a second number of individual posts related to the cluster in the second plurality of posts within a first limited time frame, and calculating the difference between the first number and the second number. In some embodiments, wherein the second limited time frame is a time period immediately after the first time frame. In some embodiments, a length of time of the first time frame is equal to a length of time in the second time frame

In yet another aspect, the invention includes a computer implemented method for establishing a new keyword for a topic. In some embodiments the method includes having a keyword threshold, receiving a plurality of individual posts as social media post data, identifying a noun phrase in the plurality of individual posts, identifying a predetermined keyword in the plurality of posts, determining a number of posts in the plurality of posts that have both the noun phrase and predetermined keyword, and identifying the noun or noun phrase as a keyword when a number of posts using the noun or noun phrase reaches the keyword threshold, creating a first keyword with the noun or noun phrase. In some embodiments, the method includes identifying a second plurality of individual posts within the plurality of individual posts that contain the first key word and relating the second plurality of individual posts to the topic. In some embodiments the keyword threshold is a measurement of a number of posts containing a word or phrase over a limited period of time. In some embodiments the keyword is removed when the number of posts using the noun or noun phrase drops below the threshold.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is an exemplary network environment for a social media processing engine used to determine a poster's intent from text data such as social media post data.

FIG. 2 is a flow chart illustrating exemplary processes in one embodiment of a social media processing engine.

FIG. 3 is a flow chart illustrating an exemplary method of separating data within a social media post with the social media processing engine of FIG. 2.

FIG. 4 is a flow chart illustrating an exemplary method of automatically generating keywords that identifies social media posts related to a particular topic, wherein a social media processing engine may monitor for posts that contains the generated keywords.

FIG. 5 is a flow chart illustrating an exemplary method of dynamically creating new topics.

FIG. 6. is an exemplary state diagram illustrating a poster's intent level.

FIG. 7 is another exemplary state diagram illustrating a poster's intent level which allows for state transitions based on specific intent determinations.

FIG. 8 is an example of annotations and sub-annotations that may be attached to a likely viewer intent post by the social media processing engine.

FIG. 9 is an example of annotations and sub-annotations that may be attached to a interested viewer intent post by the social media processing engine.

FIG. 10 is an example of annotations and sub-annotations that may be attached to an undecided viewer intent post by the social media processing engine.

FIG. 11 is an example of annotations and sub-annotations that may be attached to a not interested viewer intent post by the social media processing engine.

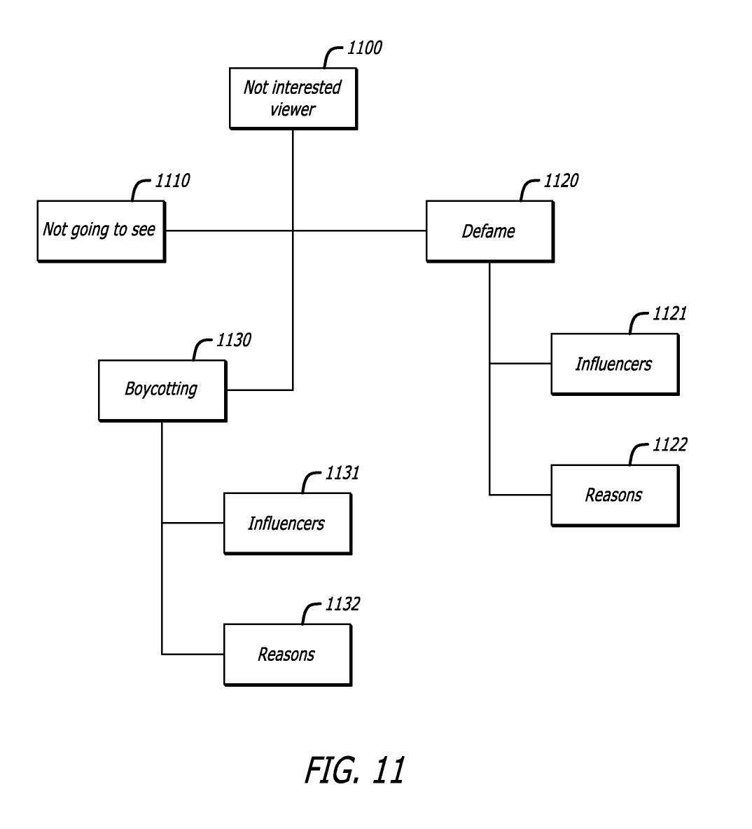

FIG. 12 is an example of annotations and sub-annotations that may be attached to a subscription product rather than a viewable product by the social media processing engine.

FIG. 13 is an example of annotations for a post that is tagged as having the action “viewed” by the social media processing engine.

FIGS. 14A-14B are exemplary graphics provided by the social media processing engine on aggregated data.

FIG. 15 is an exemplary computer system that may be used as part of the social media processing engine.

FIG. 16 is an exemplary illustration of several features of the various embodiments of a social media processing engine and how the features may interact.

### DETAILED DESCRIPTION OF THE PREFERRED EMBODIMENTS

As will be described hereinafter in greater detail, the various embodiments of the present invention relate to a system and method for processing social media data to derive intent of an individual poster. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

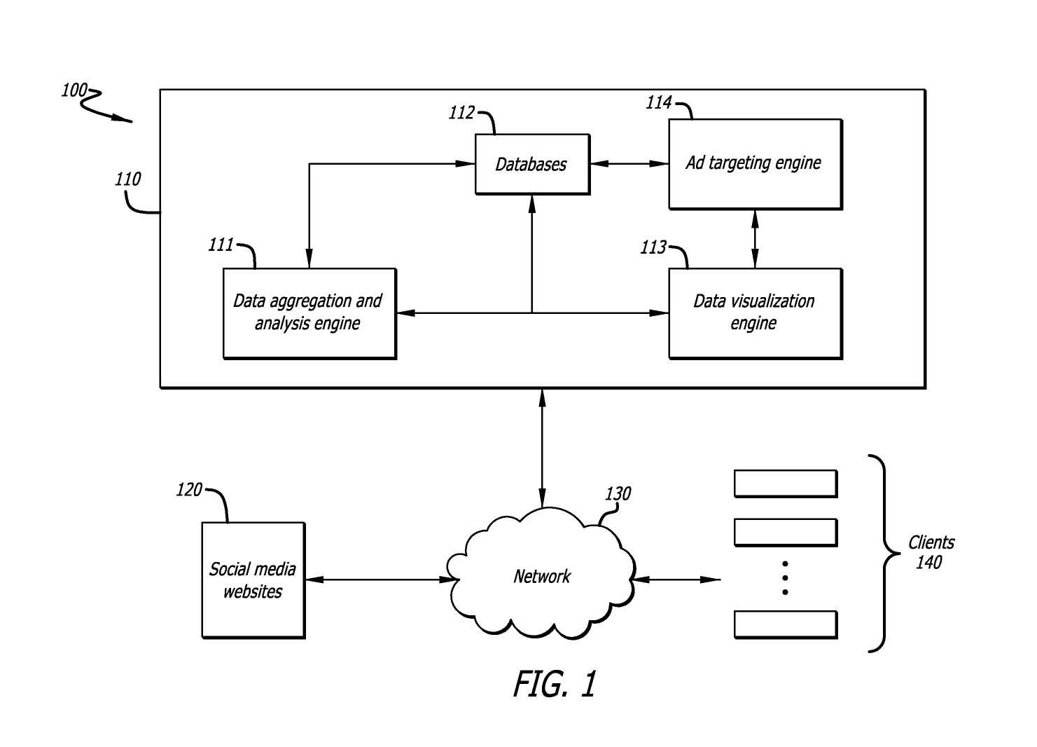

FIG. 1 is an exemplary network diagram of a system environment 100 for conducting data analytics on social media. System environment 100 may have a social media processing engine 110 for processing and analyzing social media data and client requests. In an alternative embodiment, social media processing engine 110 may be configured for processing any textual data, including social media data. Social media processing engine 110 may be made up of hardware and software components such as computers, routers, servers, databases, operating systems, and applications in a distributed configuration.

According to this exemplary embodiment, social media processing engine 110 may have a data aggregation and analysis engine 111, databases 112, data visualization engine 113, and ad targeting engine 114.

In one embodiment, social media processing engine 110 may be configured to receive and/or retrieve social media data from social media websites 120 through a connection to a network 130. Social media data may include, but is not limited to, posts and profiles from blogs, forums, YouTube®, Reddit®, Instagram®, Vine®, Twitter®, Facebook®, Google+®, RSS feeds, and the like. Social media processing engine 110 may also receive or retrieve other internet data, such as internet news feeds and/or other information or content from particular websites for aiding its social media data processing. Data aggregation and analysis engine 111 may process and analyze the social media data for storage into one or more databases 112. In an alternative embodiment, Data aggregation and analysis engine 111 may be separated into multiple engines assigned with different tasks. For example, the portion of the Data aggregation and analysis engine 111 that analyzes, and stores incoming raw social media data may be separated from the portion of the data aggregation and analysis engine 111 that conducts analysis on the post aggregated social media data in database 112.

In one embodiment, databases 112 may have different databases that are dedicated to certain information. According to one embodiment, databases 112 may be made up of multiple databases. Each database within databases 112 may be dedicated to a particular information type. For example, there may be one or more databases dedicated to storing data related to the attributes and characteristics of posters to social media websites. Another set of databases may contain data resulting from analysis by data aggregation and analysis engine 111. Yet another set of databases may be dedicated to analysis conducted by data visualization engine 113 and ad targeting engine 114. In these configurations, the data in each database may have pointers or references to each other. Alternative embodiments may split data among databases in different manners. In yet another alternative embodiment, a single database may be used to store all the data.

Data visualization engine 113 may prepare data for display in web widgets and for on-air television broadcasts and/or display on a graphical user interface (GUI). In one embodiment, data visualization engine 113 provides an aggregate analysis of the data stored in database 112. The data visualization engine may provide outputs of its analysis to be displayed on a graphical user interface or television broadcast. The data may be provided as raw numbers or in graphs, charts, or use other methods of providing visual representations of data. Data visualization engine 113 may also analyze data in accordance with requests from clients 140.

Ad targeting engine 114 is used to focus ads to certain individuals based on the analysis by the data visualization engine 113 and/or data aggregation and analysis engine 111. Ad engine 114 may also create a demographic for ad targeting based on requests from one or more of clients 140.

Though the exemplary social media processing engine 110 depicted in FIG. 1 is split into software and hardware components, including, for example data aggregation analysis engine 111, databases 112, data visualization engine 113, and ad targeting engine 114, different embodiments may separate the software and hardware components in alternative ways. Furthermore, alternative embodiments may exclude some functionality. For example, the GUI and charting functions of data visualization engine 113 may be removed from some embodiments. In other alternative embodiments, ad targeting engine 114 may be excluded. One of ordinary skill in the art would recognize the many different social media processing engines that may be created by excluding or combining different functionalities discussed in this disclosure, all of which are contemplated here within. Although certain aspects of this disclosure may refer to the system environment described in FIG. 1, other system environments and configurations may be used and are contemplated herein as well.

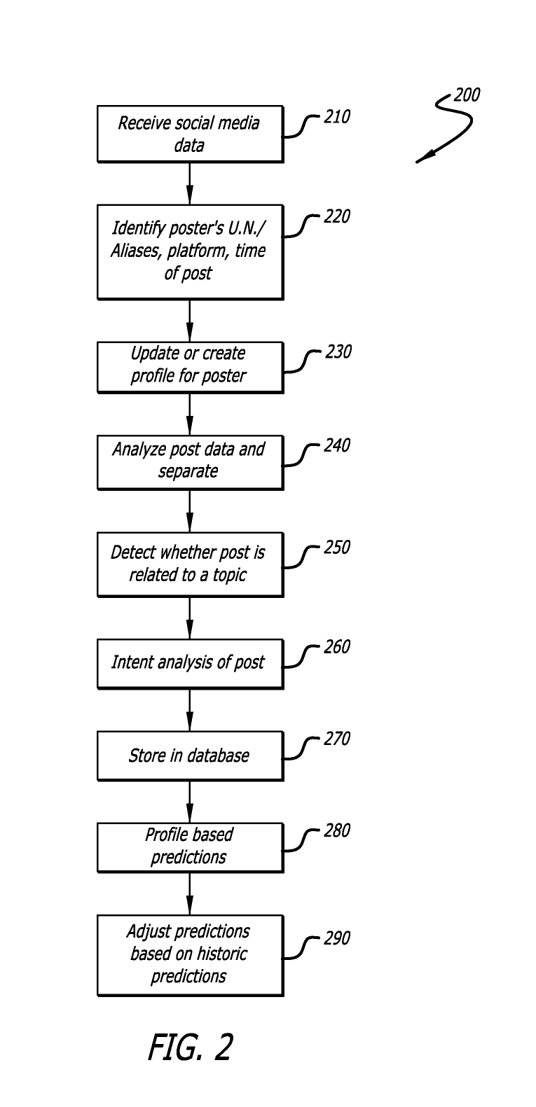

FIG. 2 illustrates an exemplary flow chart of the data aggregation and analysis engine 111 depicted in FIG. 1. At box 210, the data aggregation and analysis engine receives social media data from social media websites. The social media websites may provide access to social media data through an application programming interface (API). Some social media websites also provide “firehose” or pipeline access which provides social media data in real time. An example of a firehose is the Twitter® firehose. Twitter®'s firehose streams all Twitter® posts in real time to any program that has access to the Twitter® firehose.

If a social media website does not provide an API or access to its firehose, data aggregation and analysis engine may retrieve social medial data in other manners. For example, social media data may also be retrieved through RSS feeds and other feeds, webcrawling, and the like. Data may also be received from third-party reseller such as GNIP®, Datasift®, and the like. There are many ways to retrieve social media data, all of which are to be within the scope of the present invention.

At box 220, the data aggregation and analysis engine may compartmentalize the social media data by individual posts for simplifying the analysis of the data. For each post, the data aggregation and analysis engine may identify all metadata available on the post which may include a poster's user or account name or alias, the user's actual name, demographic information, social media account information, the poster's social media platform choice, type of message (reply, retweet, like, and other forms of messages) and a timestamp for the post (the data aggregation and analysis engine may also self-generate timestamps). This information may be used by the data aggregation and analysis engine for linking and archiving the post data with a poster's profile and/or topic (topics are discussed later in this specification). According to one embodiment, the data aggregation and analysis engine may use metadata from each social media website to determine timestamps and a poster's username. If metadata is not available, the data aggregation and analysis engine may take advantage of known data formats used by a social media website to obtain the username and timestamp of the poster and post, respectively. Additionally, the data aggregation and analysis engine may use a Natural Language Processing (NLP) engine to recognize the username of the poster. The data aggregation analysis engine may access a third party NLP engine, use its own NLP engine, or a combination of the two.

A NLP engine is a combination of hardware and software used to analyze text or speech through machine learning and/or rule based algorithms. The following is a non-exhaustive list of third party software used to create NLP engines: Attensity®, OpenNLP, Natural Language Toolkit (NLTK), Stanford® NLP, and MAchine Learning for LanguagE Toolkit (MALLET).

The data aggregation and analysis engine at box 230 may use the username/alias of the poster to check if a record of a profile for the poster exists in a profile database. If a profile of the poster exists in the profile database, the data aggregation and analysis engine may update the profile with newly received data. Otherwise, data aggregation and analysis engine creates a new profile for the poster before updating the profile database.

In one embodiment of the invention, the profile database may be a database storing data about a poster's characteristics and/or demographics. The profile database may store information such as, but not limited to, the poster's real name, age, date, geographical location, friends, connections in the social network, followers, number of followers, activity level, affiliations, race, economic status, job, interests, family relation, close friends, or any other characteristics of the poster. Updating a profile database may consist of entering newly determined information about a poster in the poster's profile. The data aggregation and analysis engine may retrieve information about a poster through several ways, including, but not limited to, the poster's own published profile, social connection graphs, and NLP predictive analysis.

Most social media websites provide a section that publishes a poster's information provided by the poster. For example, blogs often have an “about” section whereas Facebook, Google+, forums, and Twitter often times have a “profile” section. The data aggregation and analysis engine may retrieve data from a poster's published profile through an API, a web scraper, and/or any other suitable means. Depending on the social media website, the data aggregation and analysis engine may also identify information about the poster through metadata tags, such as name, age, date joined, and the like. However, this information may also be provided in an unstructured data format. In these instances, an NLP engine may be used to extract this information from a post. The data aggregation and analysis engine may then update or create a poster's profile with this information.

Another method of deriving information about a poster can be through a social media connection graph which tracks a poster's activity, social media connections, and interactions of a social media site, including but not limited to how much content is sent to a particular social media connection. Social connections include, for example, the poster's followers, the people the poster follows, friend links, likes, favorites, +1's, and other social connections.

In one example, The data aggregation and analysis engine 230 may determine a importance and/or influence measurement of a user using the social media graph by analyzing who the user is connected to and how many connections the user has.

In another example, a social media connection graph can help determine a poster's location. After determining all the social media connections of a poster, the data aggregation and analysis engine may determine a poster's geographical location by searching for geographical tags on all the social connections the poster has. The data aggregation and analysis engine may predict that the poster is located geographically where the poster's social connections are most densely located. In one embodiment, the social connection graph may limit its analysis to a particular timeframe of a poster's activity. This allows for the data aggregation and analysis engine to predict the poster's location for a particular timeframe.

The data aggregation and analysis engine may also update a poster's profile by using a NLP predictive analysis on the textual portions of a post to identify relevant information. NLP predictive analysis may also be conducted by combining NLP engines with classification algorithms. As one example, the data aggregation and analysis engine may use an NLP engine to identify the poster's vocabulary, semantics, writing style, and other unique linguistic features in combination with one or more clustering algorithm (one of many different classification algorithms) to determine the poster's place of origin or place of residence and other characteristics.

For example, the data aggregation and analysis engine may use the NLP engine to determine if a post contains slang. If slang is identified, the data aggregation and analysis engine may use a clustering algorithm to predict a poster's geographical origin by clustering other posters that have also used the same slang. For example, “hella” tends to be a Northern California slang term. Similarly, “wicked” is frequently used by people from Boston. The data aggregation and analysis engine when conducting a clustering algorithm on posters that use the term “hella” may find certain attributes that a majority of these posters share. The data aggregation and analysis engine might find, for example, that 70% of posters that use the term “hella” were geographically located in California and also loved Starbucks.

NLP predictive analysis may also use slang to predict age group and gender. For example, an NLP engine may identify the phrase “never sink” as a unique linguistic feature. Using a classification algorithm, the data aggregation and analysis engine may find that this phrase is loosely linked to females born in the late 1990's.

Slang can also be used to predict many other attributes of a poster. It may be used to predict the geographical region a poster attends (or attended) college, or if they are of college age. One example is based on how a poster refers to organic chemistry. Students who have gone to east coast colleges tend to shorten the word “organic chemistry” to “Orgo,” while west coast students often shorten it to “O-Chem.”

NLP predictive analysis may also determine an age group from the type of vocabulary used. For example, it is unlikely that a ten-year-old kid would use the phrase “regression analysis.”

The data aggregation and analysis engine may also combine an NLP engine with an algorithm to track accelerated use of a word or phrases to find trends among certain demographics of posters. A phrase or acronym may suddenly become very popular amongst a certain group of people. These discovered trends can be analyzed with one or more clustering algorithms to predict attributes of a poster.

In addition to using an NLP engine and classification algorithms to predict attributes, the data aggregation and analysis engine may also use classification algorithms on a poster's profile and interests to predict attributes of the poster. For example, some movies and television shows are generally followed by a certain cross-section of the population, so a prediction of certain attributes may be derived from those interests. In one example a classification algorithm is used to analyze a poster's television show interests. The classification algorithm may find that posters interested in the children's programming, such as Sesame Street, are likely to be pre-teens or have a pre-teen in their household.

The data aggregation and analysis engine may use one or more of the above techniques to populate a poster's profile with characteristic attributes. According to one embodiment, attributes entered into the database may be tagged, organized, or have separate data fields specific to the method in which the attribute was derived. Additionally, the data aggregation and analysis engine may provide a weighting system for analyzing conflicting attributes. For example, attributes pulled from a poster's profile may override attributes derived from the NLP engine or derived from the poster's interest but not both. Alternatively, instead of having higher weighted information sources override lower weighted attributes, the combination of weights may determine how to update the database. As by way of example and not by limitation, a user's profile may state that they are 15 years old. This information source may be given a weight of 1. The database may have a previously entered age of 14. This source may be given a weight of 0.5. Additionally, there may be a recent post “I just turned 16.” Due to the immediacy of the post, the weight of this information source may be 10. The weight of the most recent post may change over time. Due to the immediacy of the recent post, this post may overrule the other information sources. However, information sources with identical attribute predictions may add together to override other information sources with higher weights.

The Table below is a visual illustration of how an exemplary profile may be organized within a database.

| User Name/ | | NLP | | |
|---|---|---|---|---|
| Alias: | Profile | Predictive | Social | Profile |
| LAGirl | Scrape | Analysis | Connection | Predictions |
| Name | Michelle | Michelle | | |
| Age | 100 | 13-16 | 13-15 | 16-23 |
| Gender | Female | | Female | Female |
| Residence | Santa Monica, | Los Angeles, | Santa | |
| | California | California | Monica, CA | |
| TV Shows | | | Adventure | |
| | | | Time, | |
| | | | Vampire | |
| | | | Diaries | |
| Movies | . . . | . . . | . . . | . . . |
| Clothing | . . . | . . . | . . . | . . . |
| Sports | . . . | . . . | . . . | . . . |

In this example, the poster has a username or alias “LAGirl.” The top row lists the derivation method for LAGirl's profile. Information scraped from LAGirl's profile are organized in the “Profile Scrape” column; predictions made based on linguistics are provided under the “NLP Predictive Analysis” column; and so forth. The left column lists the attribute type. The table is a non-exhaustive list of attributes and methods of deriving information and is only provided as an example. In another embodiment, the user's profile may be social network independent and may contain multiple identifiers such as their account names from Twitter®, Facebook®, Tumblr®, and the like.

Referring back to FIG. 2 at box 240, the data aggregation and analysis engine may divide the post data into partitioned categories for separate analysis. The data aggregation and analysis engine may, for example, use metadata to identify certain characteristics of the post. One example would be to identify portions of a post that are plain text, links, pictures, reposts, and/or quotes.

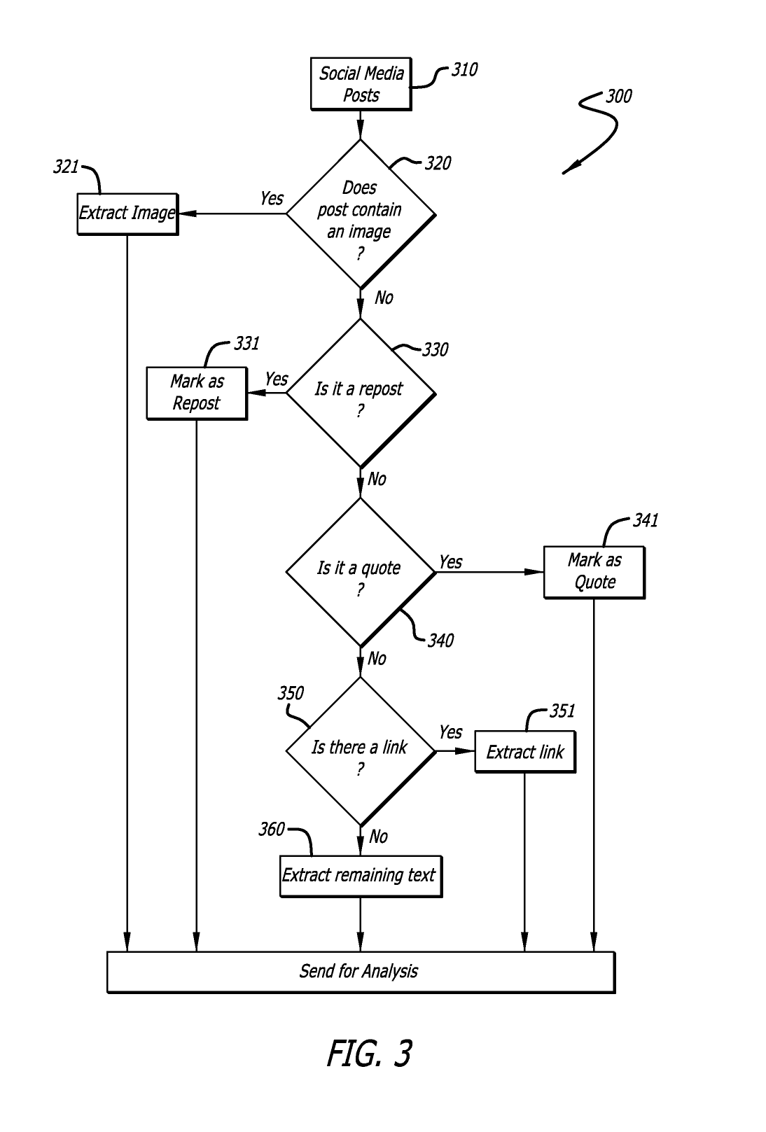

FIG. 3 illustrates a flowchart for an exemplary system 300 for processing a particular post. At box 310 a social media post is received. System 300 initially checks to see if any images are contained within the post at 320. If the post contains an image, the image is extracted for analysis at box 321.

Next, at 330, system 300 checks to see if the post is a repost. A repost is previously posted content on a particular forum. Reposts are often, but not necessarily, by a different poster. The data aggregation and analysis engine may easily identify reposts through metadata provided by the social media website. For example, Facebook® provides a “share” function for easily reposting content. Similarly, Twitter® has a “retweet” function. Alternatively, the data aggregation and analysis engine may determine whether a post is a repost by comparing new posts to a database of archived posts. If the post is a repost, it is marked as such at box 331 and sent for further analysis by the data aggregation and analysis engine.

At box 340, system 300 checks to see if the post is a quote. Similarly to reposts, quotes can also be identified using metadata. One example of easily identifiable quotes are quotes in forums. Forums usually provide a quote function to provide posters a way of indicating that the poster is repeating another post. Sometimes the quote provides the original poster's alias as part of the quote. Additionally, system 300 may determine whether a quote is in a post through the use of quotation marks and/or attribution. For example, the message ““That was so awesome”—Alejandro” has both quotation marks and attribution to Alejandro. System 300 may be configured to identify the quotation marks and/or the attribution to identify this message as a quote. System 300 extracts any quotes at box 341 for individual analysis. System 300, at box 350, checks the post for a link to a website; if a link exists it is extracted for analysis at 351. Finally, the remaining text is extracted at 360 and sent for analysis by the data aggregation and analysis engine.

In an alternative embodiment, system 300 may use metadata to identify additional or alternative post characteristics, such as whether the post contains video, hashtags, @ tags, username tags, and the like. In some cases, websites may not provide metadata that identifies post characteristics. In these cases, system 300 may use a NLP processing engine to identify post characteristics based on symbols such as hashtags, @ tags, and the like. Additionally, system 300 may use different partitioning systems for different social media websites. The data aggregation and analysis engine may have unique methods of processing posts for each social media website because social media websites may have differing data formats from each other. FIG. 3 is just one example of how post data may be separated for one particular social media website, and is not meant to be exhaustive.

Referring back to FIG. 2 at box 250, the data aggregation and analysis engine analyzes the separated data to determine whether they relate to a monitored topic. Topics may be an event, person, item, subject, or anything that may be of interest. The data aggregation and analysis engine may monitor posts related to select topics for analysis.

In one embodiment, the data aggregation and analysis engine may conduct additional analysis on the separated data to determine whether the post relates to a monitored topic. The data aggregation and analysis engine may follow website links from within a post and extract data from the linked website for topic matching. For example, a poster's post may link to an article, and the data aggregation and analysis engine may extract the headline, author, or other data from the article for determining whether the article matches any topics.

According to one embodiment, clients may create the topics that the data aggregation and analysis engine monitors. For example, a client may want to monitor the reception of a new film. The client enters in the name of the film and any key words or phrases that indicates that a post is associated with that film. Examples of related keywords for a film may be, for example, names of actors, directors, producers, etc. Data aggregation and analysis engine may then create a database for that particular topic and analyze posts that contain the client entered topics and keywords/phrases.

In one embodiment, the data aggregation and analysis engine may also dynamically determine additional keywords and phrases for monitoring. For example, social media posters may gravitate to a particular quote from a trailer and repeat it. Another example may be a lesser known actor, whose name isn't part of the client created key word list, but who becomes very popular and discussed regularly in social media posts. In these cases, the data aggregation and analysis engine may identify these additional key words for monitoring and analysis.

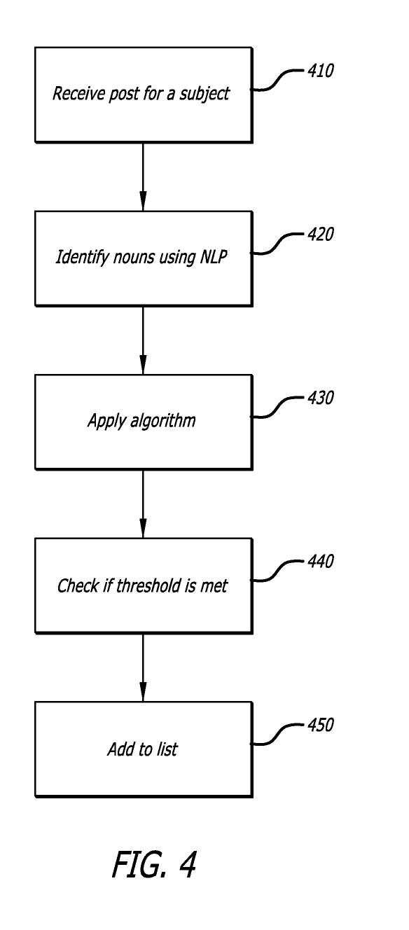

FIG. 4 is a flow chart illustrating one method of determining additional key words or phrases that may identify a post as being related to a topic. At box 410 a post is identified as being related to a predetermined topic. This identification may be through key words and phrases entered into the system by a client. At box 420, an NLP engine configured to detect proper nouns is used to identify all proper nouns within a post. At box 430, the data aggregation and analysis engine identifies proper nouns that do not match a keyword or phrase in the system, the proper nouns are then stored in a database as a keyword or phrase that is potentially linked to the client's topic. At box 440, an algorithm is used to determine if a keyword or phrase is related to a particular topic. The algorithm may be a simple algorithm which sets a threshold number of posts for unlinked keywords. When a certain number of posts related to a topic also uses a particular unlinked keyword or phrase, the keyword or phrase may be automatically linked to the topic.

In an alternative algorithm, the threshold may have to be met within a certain period of time. In yet another alternative, an algorithm may be used to check for accelerated use of a particular keyword in relation to a topic. In still another alternative, and algorithm may use a percentage of posts threshold, where a certain % of posts with an unlinked key word is used with a linked keyword, for determining additional keywords. Other embodiments may use a combination of these along with other algorithms. At box 450, once certain criteria of the algorithms are reached, the keyword may be added to the list of keywords monitored for a topic by the data aggregation and analysis engine.

In an alternative embodiment, dynamically created keywords may be removed when one or more criteria is no longer met. For example, a criterion might be that the keyword must be used in relation to a client entered keyword at least 100 times within the last 24 hours. The data aggregation and analysis engine may stop monitoring a keyword or phrase if this criterion is no longer met.

Furthermore, the data aggregation and analysis engine may identify pictures, links, hash tags, and other post data other than text as being related to a topic. For example, a video or photo may come up regularly in relation to a particular topic keyword. The data aggregation and analysis engine may store these videos and/or photos in a database for use as indicators that a post is related to a particular topic.

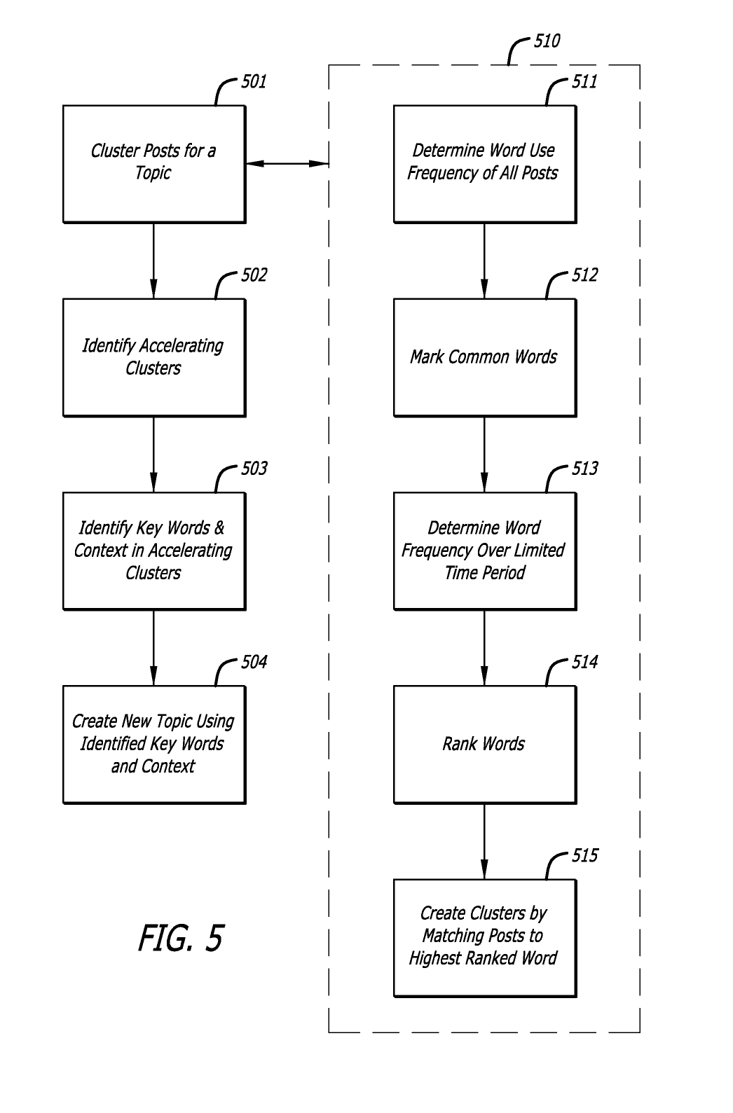

FIG. 5 is a flow chart illustrating an exemplary method of dynamically generating new topics. At box 501 the data aggregation and analysis engine may cluster posts for a particular topic using a clustering algorithm 510.

There are many ways in which clustering algorithms can develop clusters. Algorithm 510 illustrates one exemplary method of a clustering content or posts within a topic. At 511 the data aggregation and analysis engine determines the frequency of each word used in all posts for a particular topic. At 512, words which have a frequency above a predetermined threshold may be marked as “too common.”

At 513 the data aggregation and analysis engine determines the frequency of all the words used in posts for a particular topic within a limited time frame. In one embodiment, the limited time frame is ten hours. Other time frames may be used in alternative embodiments. In one embodiment, the limited time frame may be optimized based on how much post traffic a topic has.

At 514 the data aggregation and analysis engine ranks words in a post based on the frequency of the word in a limited time frame and the total use of the word over all collected posts. In one embodiment, the rank of a word may increase the more the word has been used in the limited time frame. At the same time, the data aggregation and analysis engine may lower the rank of a word the more a word has been used in all collected posts. In one embodiment, the ranking value may be determined by dividing the number of words in the limited time frame by the number of times the word is used in all posts. Other methods of ranking trending words would be apparent to one skilled in the art and are contemplated herein.

At 515 the data aggregation and analysis engine may cluster posts by matching posts from a particular topic to ranked words in order of highest ranked to lowest rank. If no appropriate cluster words are in a post, the post is not clustered. In an alternative embodiment clustering algorithm 510 may be configured to use pairs of words and/or groups of words rather than a single word.

At box 502 the data aggregation and analysis engine may analyze the identified clusters for acceleration (such as share count over a period of time) and/or total amount of sharing. The data aggregation and analysis engine may identify clusters that cross a predetermined threshold. In one embodiment a threshold may be based on total cluster shares within a certain time frame. For example, a threshold may be whether there are at least 1,000 shares of the cluster in a day. In another embodiment, a threshold may be based on the acceleration of a cluster being shared. For example, an accelerating threshold may be where the number of people sharing a cluster is exponentially increasing by a factor of three over an hour. In yet another embodiment, a combination of both total shares over a period of time and acceleration may determine the threshold. One of ordinary skill in the art would also recognize other thresholds that would identify trending topics. A client or a user may adjust the threshold levels to balance sensitivity and accuracy in identifying trending clusters.

At box 503, the data aggregation and analysis engine may identify important keywords and context with clusters that pass a certain threshold using an NLP engine. In one embodiment, keywords may be identified by finding words that appear in more than a certain number of posts, for example, words that appear in more than 70% of all posts

The data aggregation and analysis engine may also calculate the frequency the key words have been shared in a short period of time, such as two hours, to identify unique contextual words such as a person's name or a name of a place. The data aggregation and analysis engine may also check the use of a word used from all collected posts to identify important key words that identify a topic, such as, “shooting” or “explosion.”

At box 504 the data aggregation and analysis engine creates a new topic based on the keywords and context determined in box 503. This topic may measure a trending cluster in more detail than the parent topic. In one embodiment, the dynamically created topic may stay in existence only while the volume and acceleration of that topic stays above a certain threshold. When the volume and/or acceleration of that topic falls below that threshold, the topic may be removed.

Referring back to FIG. 2 at box 260, assuming the data aggregation and analysis engine determines that a post is related to a topic being monitored, it may analyze each separate piece of data from the post. The analysis may depend on the data type.

With regards to plain text data, the data aggregation and analysis engine may analyze this data with an NLP engine. The NLP engine may be used to help predict an intent the poster may have towards a topic or whether an action occurred with regards to a topic.

Intent, as discussed herein, is referring to the level of resolve a poster may have in acting a certain way with a topic. For example, if a topic was a movie, the possible intents may be “likely to view”, “interested in viewing”, “undecided in viewing”, and “not interested in viewing”. Alternatively, if the topic were a product (such as a smart phone) intents may be “likely to buy”, “interested in buying”, “undecided in buying”, and “not likely to buy”. Though the levels of intent are broken into likely, interested, undecided, and not interested, the data aggregation and analysis engine may use more or less granularity in categorizing the levels of intent of the poster as evidenced by the data contained in the post.

Actions, as is implied, are whether a poster acted in regards to a particular topic. Actions may include, but are not limited to, whether a poster bought, saw, used, read, wore, or subscribed to a topic. The type of action may differ depending on the topic. For example, someone cannot eat a dress or wear a movie. In one embodiment, a client may provide the action types that best relate to a topic. In an alternative embodiment, the social media processing engine may require a category entry for a topic that indicates the type of action that would be associated with the topic. Some examples of categories may include “viewable,” “edible,” and/or “usable.” The data aggregation and analysis engine may then automatically determine the types of actions to monitor based on the client's category choice.

The data aggregation and analysis engine may derive a poster's intent from the words or phrases the poster uses. In some cases a poster may indicate a specific intent within a post. An example of specific intent in a post may be a Twitter® post that states “Planning to watch @ safehavenmovie again with my baby brother. One great movie, I just won't get tired of watching it over and over again.” Using an NLP engine configured to identify specific intent type language, the data aggregation and analysis engine determines that this person has stated a specific intent to watch the movie Safe Haven. In a situation such as this, the data aggregation and analysis engine may indicate that this post is related to the topic “Safe Haven” and has a specific intent level of “likely.” Another example may be a Twitter post such as “okay I'm not gonna go see safe haven. I've been hearing bad reviews about it.” Here, there is a specific intent not to watch safe haven, so the data aggregation and analysis engine may record that this post for the Safe Haven topic has a specific intent of “not interested.” In one embodiment, data aggregation and analysis engine may establish a level of resolve the language in a post conveys based on the words used in the post.

Sometimes posts may not provide a definitive statement as to whether or not a user is intending to take an action in relation to a product. In these instances, the data aggregation and analysis engine may derive an intent from the post. Statements such as “someone go see #Safehaven® with me :(” indicates an interest but no affirmative intent to do anything. The data aggregation and analysis engine may mark these types of posts as interested. Other statements may have more neutral, undecided, and/or mixed sentiments such as “they keep advertising Safe Haven, but I don't understand the plot” or “I love Julianne Hough, but it looks too dark for me #Safehaven®.” The data aggregation and analysis engine may mark these posts as undecided.

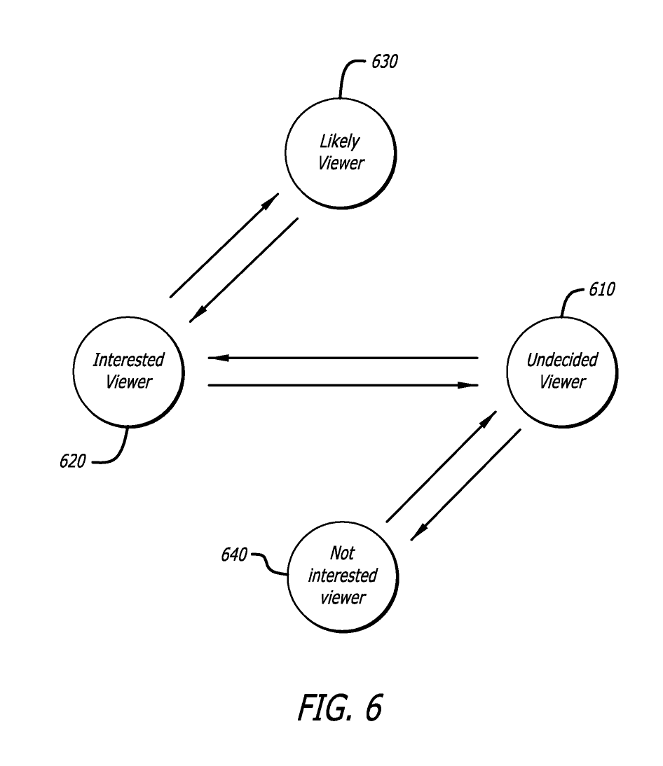

The intent derived from a poster's post may affect an interest state of a poster for a particular topic. FIG. 6 is a state diagram illustrating how a poster's state with respect to a topic may change based on new posts according to an embodiment. The data aggregation and analysis engine may initiate or default all posters to an undecided state 610 for each topic. Alternatively, the default state may be no intent until the data aggregation analysis engine assigns an intent. After the data aggregation and analysis engine analyzes a post, the intent state of the poster may change one step up or down depending on the intent level of the post. In an alternative embodiment, the intent state may be able to jump from any state to any other state depending on the intent level of the post. In one embodiment, each single post may change the state up or down depending on the intent level the NLP engine derives from the post. For example, A user in the undecided state 610 may transition to the interested state 620 or likely state 630 after making one or more “interested” or “likely” posts. These types of posts may tend to pull a state towards the “likely” state 630. Posts marked as undecided may bring states towards the “undecided” state 610, and not interested posts may pull all states towards the “not interested” state 640. In another embodiment, the data aggregation and analysis engine may require more than one post of a specific intent level to change an assigned intent state to a different intent state. For example, the data aggregation and analysis engine may require three “interested” posts, or two “likely” posts, to move a state up one position. In one embodiment, the data aggregation and analysis engine may change a poster's state to different intent states from a single strongly positive or negative statement. A weight of the significance of the intent and the state of the intent can be assigned by the NLP engine. The intent history of the user and the users' current state in the state diagram, FIG. 6, can be used to determine the new intent state of the user. Repeated interested statements could move a user from the undecided state to the interested state. Or even the interested state to the likely state. A not interested viewer could immediately become a likely viewer by posting a message that is categorized as likely with high significance such as a statement like “My bf is taking me to safe haven tonight!”

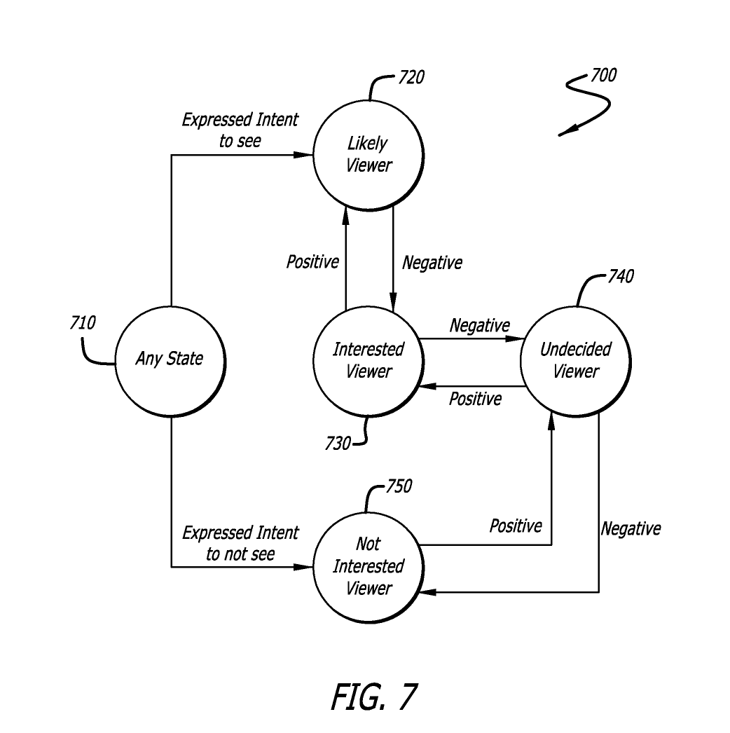

In an alternative embodiment, posts with specific intents may change a state to the derived intent no matter the current state. FIG. 7 is a state diagram 700 that illustrates an exemplary state change when a specific intent is detected by the data aggregation and analysis engine. State 710 may be the current intent state for a poster. When a specific intent is detected, the state may change to one of the two specific intent levels of “likely” 720 or “not interested” 750. Later posts that do not provide a specific intent may change the state up or down one state level similarly to the method described in FIG. 6.

In cases where the data aggregation and analysis engine analyzes non-text social media data, the engine may derive intent by analyzing other posts with the non-text social media data. For example, non-textual posts, such as a picture, may be given an intent level derived from another post. For example, if different posters all post an image following negative textual language, a 5th post of the picture without any accompanying text may be categorized as negative intent. Similarly, any non-textual information from a social media post can be tied to text. If a piece on non-text data is repeatedly found to be associated with “not interested” viewers, that piece of content could be flagged as being a “not interested” type of content and then used in the intent classification. Links may be treated similarly as pictures. Additionally, the data aggregation and analysis engine may also use a scraper to scrape the data from the linked webpage to be analyzed for positive or negative intent. In one embodiment, the text content within a link may be combined with the text of the post to determine the user's intent. Additionally, a data aggregation and analysis engine may rely solely on the text content within a link to determine an intent.

The data aggregation and analysis engine may also use an NLP engine to determine whether a particular action occurred such as “subscribed,” “bought,” “sold,” “canceled,” “watched,” and the like. In one implementation, the NLP engine may limit its determination depending on the subject. For example, if the subject is a TV show or a Movie, the NLP engine may only look for words, phrases, or other content relating to buying tickets, subscribing to a channel/video service, or watching a show.

When an action is detected for a particular topic, the data aggregation and analysis engine records the action and may use the detected action to determine the accuracy of other state predictions. For example, the data aggregation and analysis engine may use past historic predictions to determine a confidence level for either a particular profile or for profiles in general. For example, the system may keep a running statistic on how often a prediction is correct. If, for example, 50% of all “likely to act” predictions are confirmed, then the data aggregation and analysis engine can augment its prediction calculations with this statistic. The system may create a confidence level for each intent level. For example, the system might determine that only 20% of the “interested” profiles end up acting, 5% of the “undecided” end up acting, and 0.001% of the “not interested” end up acting. Because is it difficult to confirm non-actions, the system may assume non-action after a certain time limit.

In an alternative embodiment, other statistical analysis may be conducted on profiles to determine intent predictions. For example, a user who shares various movie trailers for a single film at least three times, shares two links to articles discussing the film, and at least three generic but interested Twitter Tweets® may be 85% likely to see a film.

Intent predictions may also come with additional annotations that give insight to the reasoning or useful commercial information in relation to a particular post. Annotations may provide tags; for example, a likely determination on a post having a “promoter” annotation or “not interested” determination may also have a “defaming” or “boycotting” annotation. The annotations may differ depending on the topic.

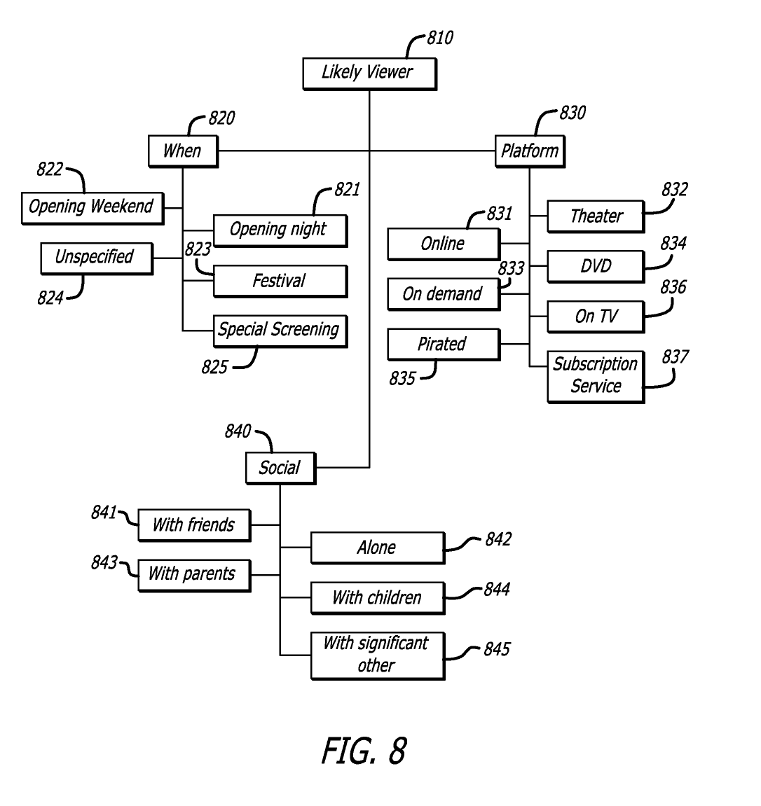

FIG. 8 illustrates exemplary annotations that may be attached to a “likely” intent level regarding a television show or movie. Because television shows and movies are things that people watch or view, the intent category is likely “viewer” 810. The likely intent level may have annotations such as “when” 820, “platform” 830, and “social” 840. Each annotation may contain additional sub-annotations with other relevant information. The relevant information may be predetermined or dynamic. An NLP engine may identify the relevant information. In this example, the “when” annotation 820 may include “opening night” 821, “opening weekend” 822, “festival” 823, “unspecified time” 824, or “special screening” 825.

There may also be a platform annotation 830 which indicates a specific platform a poster is likely to view a television show or movie on. There may be choices such as “online streaming” 831, “theater” 832, “on demand” 833, “dvd” 834, “pirated” 835, “on television” 836, or “through a subscription service” 837 which includes but is not limited to Amazon Prime®, Netflix®, Hulu®, HBO®, and other subscription services.

There may be a social annotation 840 for who the social media poster may be watching the television show or movie with. For example, a person may be watching the television show or movie with their “friend” 841, “alone” 842, “parents” 843, “children” 844, or someone they are “romantically involved with” 845.

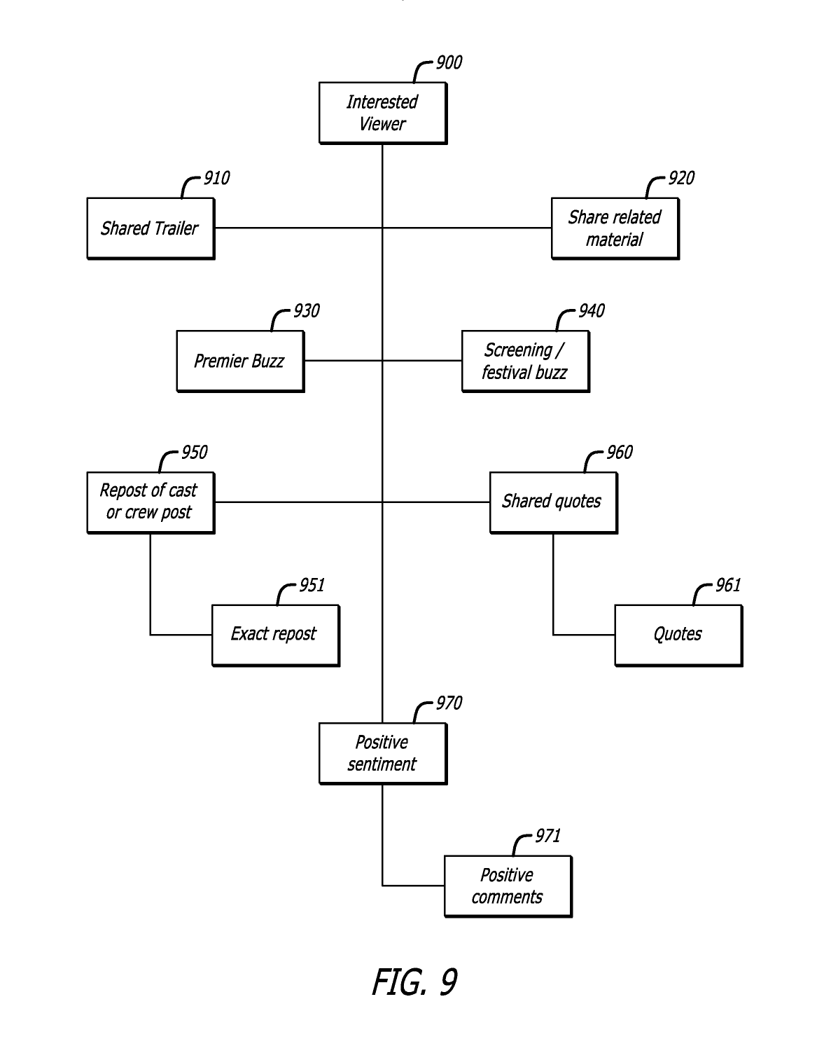

Different annotations may apply for different intent levels. FIG. 9 illustrates exemplary annotations for the “interested” intent level for a viewable product. Annotations may record useful information regarding an interested viewer, and may also identify and document something that sparked a poster's interest in a topic. This is important information in understanding effectiveness of marketing or campaigning efforts. Annotations may include for example, “shared trailer” 910, “sharing of related supplemental material” 920, “buzz regarding premier” 930, “buzz regarding reviews from festival or screenings” 940, reposts from a cast or crew 950, shared movie quotes 960, and general positive sentiment without intent language 970. Some of the annotations may record additional specific information. Reposts from cast or crew of a movie, play, television show, or other performance may include the actual post 951. Positive sentiment may include the exact comment 971. Shared quotes from a television show or movie may contain the exact quote 961.

FIG. 9 illustrates exemplary annotations for the “undecided” intent level for a viewable product. For an undecided intent level 900 there may be a neutral comment annotation 910 and a mixed comment annotation 920. The mixed comment annotations may include additional sub annotations for recording positive comments 921 and negative comments 922.

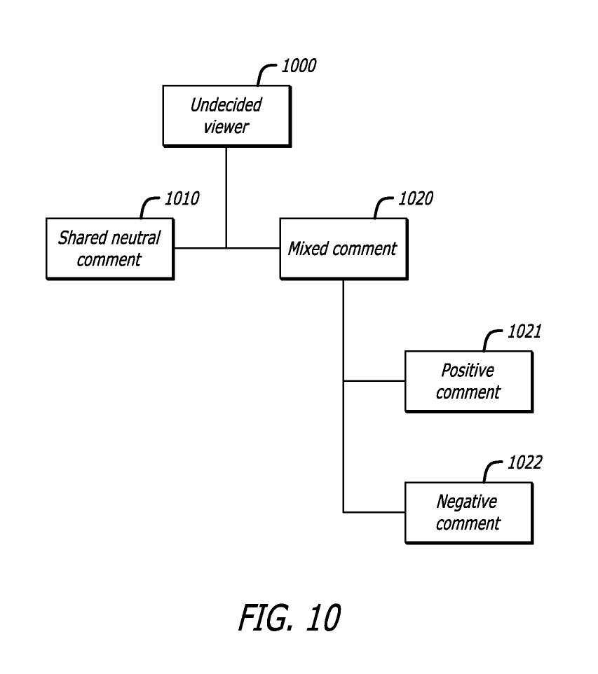

FIG. 10 illustrates exemplary annotations for the “not interested” intent level for a viewable product. For the not interested intent level 1100, there may be categorization of the language based on just general statements of “not going” 1110, “defaming” 1120, or “boycotting” 1130. The annotation may record the defaming statement 1122 or boycotting reason 1132. Additionally, the defaming or boycotting may be based on certain influencers, such as reposts, quoting, or tags. The annotation may also record these influencers as defaming or boycotting reasons 1121 and 1131 respectively.

Alternatively, if the product is a subscription service or a product consumed through a subscription service, the categories may be different. The system may treat different product categories with different annotation types. For example, the intent “likely to subscribe” might include annotations related to competitor comparisons, or features.

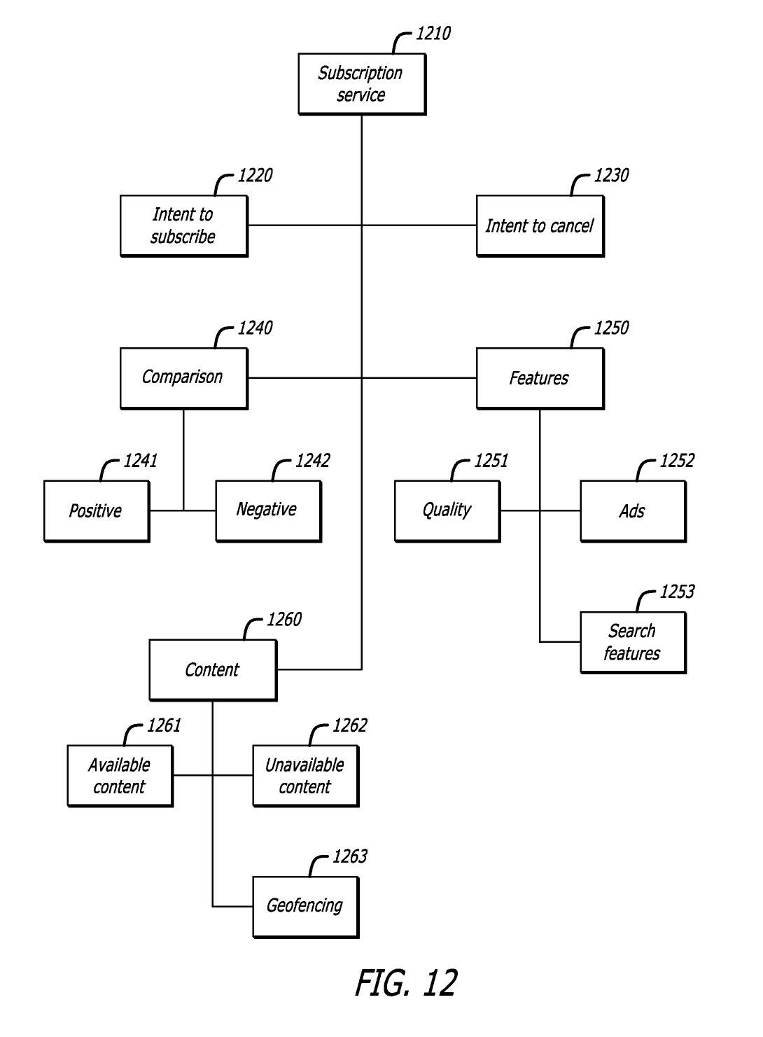

FIG. 12 shows a set of exemplary annotations that may be used for a subscription service 1210. This example shows the following annotations: intent to subscribe 1220, intent to cancel 1230, comparisons to competitors 1240, features 1250, and content 1260. Some of the annotations may have sub-annotations, for example, comparisons to competitors may record specific positive or negative comparisons 1241 and 1242. Features 1250 may have sub-annotations: comments to stream quality 1251, ads/no ads 1252, and search features 1253. Content 1260 may have sub-annotations that document discussions on available content 1261, unavailable content 1262, and geofencing 1263.

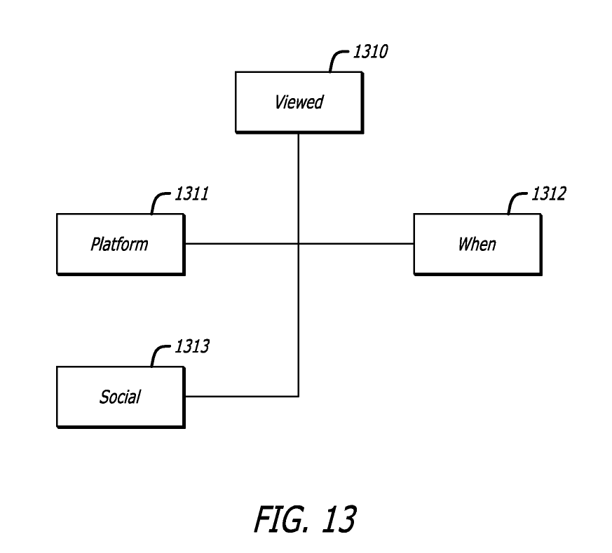

Annotations may also record actions and related information for a poster. For example, FIG. 13 shows an exemplary annotation table for a viewable product. The “viewed” action 1310 has annotations for “platform” 1311 to document the platform the poster used to view the product (television, theater, streaming, etc.), “when” 1312 to describe when the poster viewed the product (opening night, specific date, etc.), and “social” 1313 to record who the poster viewed the product with (friends, family, significant other).

Referring again to FIG. 2, at box 270, the data aggregation and analysis engine may store the post and its analysis of a post in a database and also use it to update the poster's profile. The poster's profile may also be linked to that particular post.

At box 280, the data aggregation and analysis engine may use the information in the updated or created profile to create interest predictions on certain predetermined topics. The data aggregation and analysis engine may use, for example, a clustering algorithm to find other profiles with the same or similar profiles. The data aggregation and analysis engine may also identify posters with the same age, gender, location or other attributes. The data aggregation and analysis engine may also look for similar profiles based on a combination of attributes. Based on the classification algorithms, the data aggregation and analysis engine may predict what a specific poster's intent levels are with different topics. It may also change the poster's initial intent status for a topic to a different intent setting, as described above.

At box 290, to improve accuracy of prediction based NLP analysis, the data aggregation and analysis engine may use historic predictions to determine a confidence level for either a particular profile or all profiles generally. For example, the system may keep a running statistic on how often a prediction is correct. If, for example, the data aggregation and analysis engine can adjust its predictions by 50% if only 50% of all “likely to act” predictions are actually confirmed. Each intent level may have its own confidence level. For example, the system might determine that only 20% of the interested profiles (or of a poster) act, 5% of the undecided act, and 0.001% of the not interested act. In one embodiment, the data analysis and aggregation engine correlates this analysis with consumer metrics for predictions on sales, viewership, and the like. Although FIG. 2 illustrates a flowchart of a data aggregation and analysis engine in one particular order, one of ordinary skill in the art would recognized that the data aggregation and analysis engine would also function in alternative orders than the order shown in FIG. 2. For example the data aggregation and analysis engine may detect whether a post is related to a topic (250) before the data aggregation and analysis engine identifies the poster's alias (220). Additionally, the data aggregation and analysis engine may update or create a profile for a poster (230) after the data aggregation and analysis engine does an intent analysis (260). There are many other orders in which the steps shown in FIG. 2 may be rearranged, which are all contemplated herein. In an alternative embodiment, one or more steps shown in FIG. 2 may be omitted from the data aggregation and analysis engine.

Referring again to FIG. 1, the data visualization engine 113 may use the data within databases 111 to provide answers to queries from clients. For example, a client may request the percentage of people likely to watch a movie. The data visualization engine 113 may calculate the number of social media posters in the database that are likely, interested, undecided, and not interested and provide it in a graph. In one embodiment, the data visualization engine may correlate the analytical data within the databases with known historic metrics to come up with predictions regarding the general population. For example, the ratio of historic likely, interested, undecided, and not interested social media posters for a movie can be correlated to box office performances of that movie. That correlation may be used to predict box office performances of a new movie based on the current likely, interested, undecided, and not interested social media poster ratios. This correlation can apply to almost any consumer product, such as subscriptions, television shows, voting, and the like. Other graphs may show the number of posts as a function of a time increment.

A client may limit its dataset by one or more of the data fields in the database. For example, requestors may ask for a graph showing posts that include an actress's name as a function of a unit time increment of one hour.

Clients may request a breakdown of what keywords posters use the most for a particular topic. In this manner, clients may be able to graph real time trends, demographics, interest relationships, or any other data point of aggregate social media posts that the social media engine monitors. Visualization engine 113 may display data for a particular time interval or over time in a timeline chart. The display may be provided through a dial, bar chart, pie chart, donut chart, and other known graphing charts. Visualization engine 113 may also provide a visualization of data such as total topic volume, unique messages, usernames, trending keywords/phrase, NLP entities (people places, things, products, and the like).

Additionally, clients may request for annotations that the data aggregation and analysis engine recorded. For example, if the topic is a movie, clients might request information such as what medium was used the most to watch the movie, who did the people watch it with, what is the most shared quote, picture, or comments, and any other data points. The same can be done for negative sentiment.

The social media processing engine 110 may also use data analytics to help target ads. Ad targeting engine 114 may use information in database 111 and/or the analysis from the data visualization engine 113 for targeting ads to particular demographics and/or posters. Ad targeting may be requested by a client or, alternatively, may be automated. For example, clients may request to have ads target posters with undecided intent levels for a particular topic. Ad targeting engine 114 may also automatically determine posters with undecided intent levels and have ads targeted to those posters.

Ad targeting engine 114 may also determine a particular demographic that tends to be undecided for a topic. For example, the ad targeting engine 114 may determine that posters that are in the age group between 12-16 are undecided for a particular topic, and therefore target people in that age group. Ad targeting may also, based on profiles that tend to be interested in a topic, determine other posters who would also likely be interested in the same topic and target ads to those posters.

In an alternative embodiment, the ad targeting engine may automate ad targeting for a client to posters or demographics that the ad engine 114 determines are most likely to be interested in the topic. The ad targeting engine may rely on combination of facts such as intent levels, past actions, whether the poster has acted with regards to a particular topic, most receptive demographics, brand loyalty, and the like to automatically target ads to persons meeting these criteria.

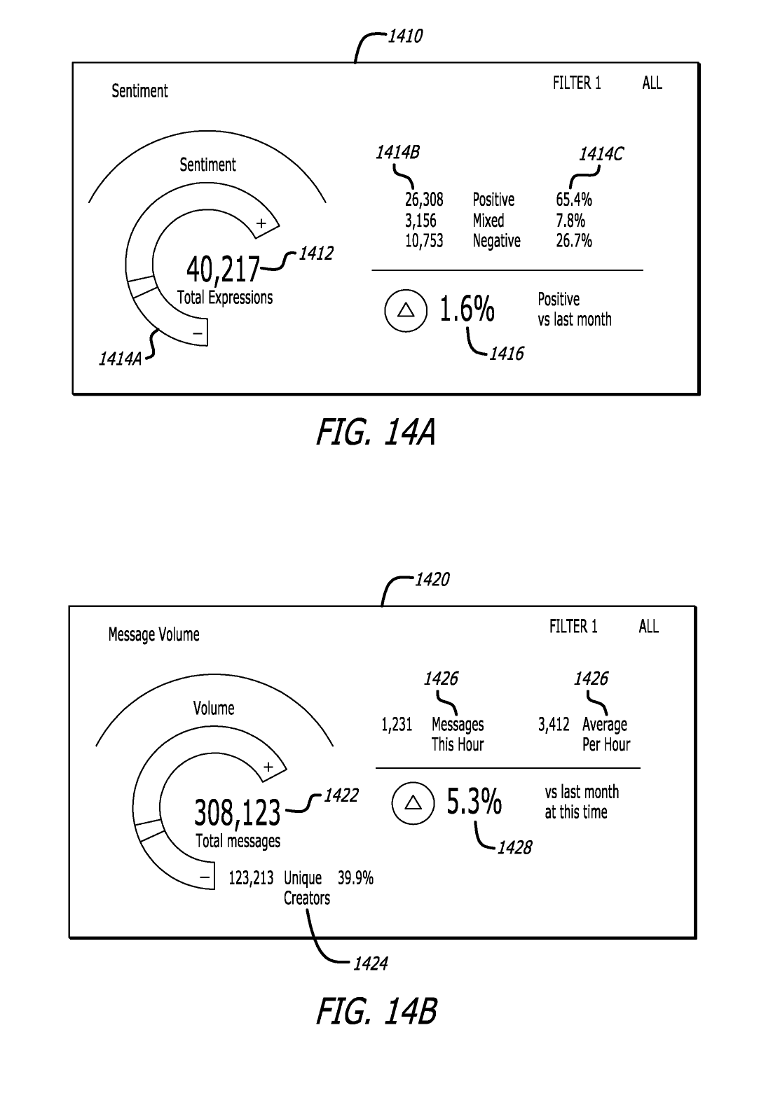

FIG. 14 illustrates an exemplary graphical dashboard provided by data visualization engine 113 according to one embodiment. The data visualization engine 113 may conduct statistical analysis on the data in database 112 and provide a visual representation of the statistical analysis. Data visualization engine 113 may provide a sentiment breakdown graphic 1410 that displays the number of messages provided for a particular sentiment as shown by reference 1412. Sentiment breakdown graphic 1410 may also provide a visualization of how the sentiment is split between positive, mixed, and negative sentiment using a graphical display 1414A. Data visualization engine 113 may also provide the number of messages that fall into each sentiment category, as shown by graphic 1414B, and the percentages of messages that fall under each sentiment category, as shown by graphic 1414C. Breakdown graphic 1410 may also provide a comparison on the sentiment over time as shown by graphic 1416.

The data visualization engine 113 may also display a message volume dashboard graphic 1420. The graphic may provide the total volume of messages that social media users have published, as shown by graphic 1422. Graphic dashboard 1420 may distinguish reposts from unique posts and provide the number of unique posts, as shown by graphic 1424. As shown by graphic 1426, graphic dashboard 1420 may also display the number of messages related to a topic per hour.

Graphic dashboard 1420 may also provide a comparison of the number of messages on a particular topic. The comparison may be provided through a numerical representation as shown by graphic 1428. Other methods of visually representing data will be apparent to one skilled in the art and are contemplated herein.

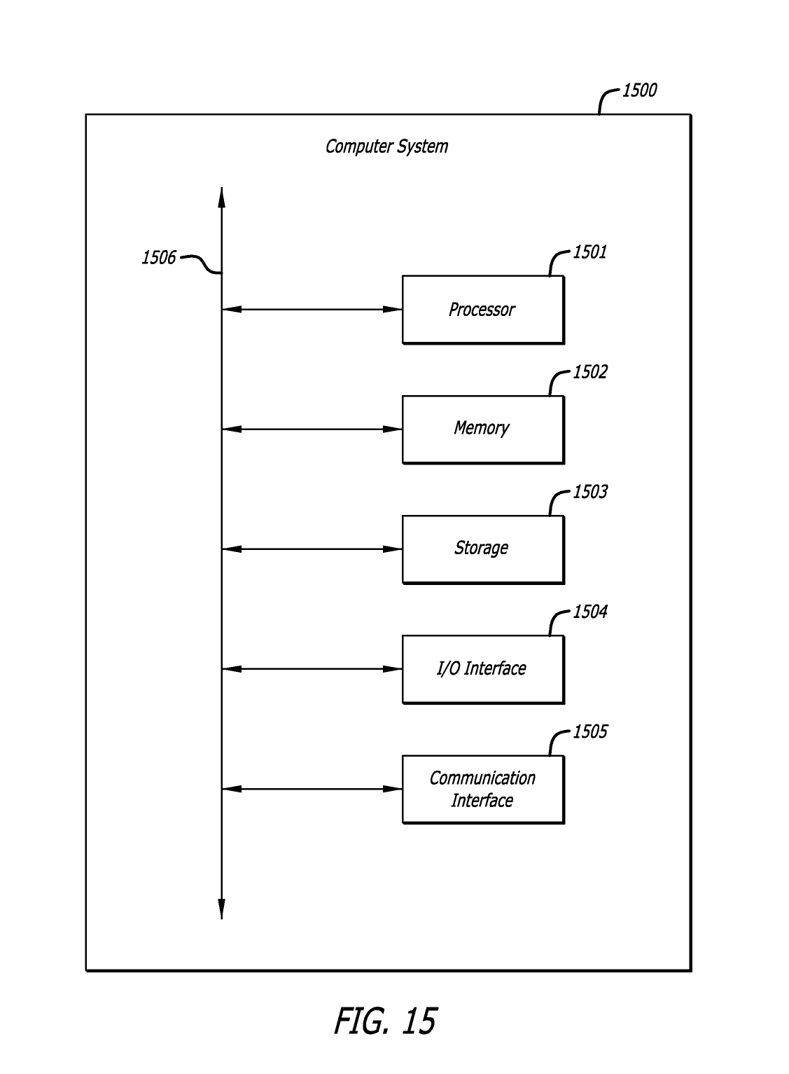

FIG. 15 illustrates an exemplary computer system 1500 which may be used with the various embodiments of the present invention. Computer system 1500 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, etc. Computer system 1500 may be a combination of multiple forms. Computer system 1500 may include one or more computer systems 1500, be unitary or distributed, span multiple locations, span multiple systems, or reside in a cloud (which may include one or more cloud components in one or more networks).

In one embodiment, computer system 1500 may include one or more processors 1501, memory 1502, storage 1503, an input/output (I/O) interface 1504, a communication interface 1505, and a bus 1506. Although this disclosure describes and illustrates a particular computer system having a particular number of particular components in one particular arrangement, this disclosure contemplates other forms of computer systems having any suitable number of components in any suitable arrangement.

In one embodiment, processor 1501 includes hardware for executing instructions, such as those making up software. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, processor 1501 may retrieve the instructions from an internal register, an internal cache, memory 1502 or storage 1503; decode and execute them; and then write one or more results to an internal register, an internal cache, memory 1502, or storage 1503. In one embodiment, processor 1501 may include one or more internal caches for data, instructions, or addresses. Memory 1503 may be random access memory (RAM), static RAM, dynamic RAM or any other suitable memory. Storage 1505 may be a hard drive, a floppy disk drive, flash memory, an optical disk, magnetic tape, or any other form of storage device that can store data (including instructions for execution by a processor).

In one embodiment, storage 1503 may be mass storage for data or instructions which may include, but is not limited to, a HDD, solid state drive, disk drive, flash memory, optical disc (such as a DVD, CD, Blueray, etc.), magneto optical disc, magnetic tape, or any other hardware device which stores may store computer readable media, data and/or combinations thereof. Storage 1503 maybe be internal or external to computer system 1500 and may be located remotely from computer system 1500, but in communication with computer system 1500, or accessible by computer system 1500.

In one embodiment, input/output (I/O) interface 1504, includes hardware, software, or both for providing one or more interfaces for communication between computer system 1500 and one or more I/O devices. Computer system 1500 may have one or more of these I/O devices, where appropriate. As an example but not by way of limitation, an I/O device may include one or more mouses, keyboards, keypads, cameras, microphones, monitors, display, printers, scanners, speakers, cameras, touch screens, trackball, and the like.

In still another embodiment, a communication interface 1505 includes hardware, software, or both providing one or more interfaces for communication between one or more computer systems or one or more networks. Communication interface 1505 may include a network interface controller (NIC) or a network adapter for communicating with an Ethernet or other wired-based network or a wireless NIC or wireless adapter for communication with a wireless network, such as a WI-FI network. In one embodiment, bus 1506 includes hardware, software, or both coupling components of a computer system 1500 to each other.

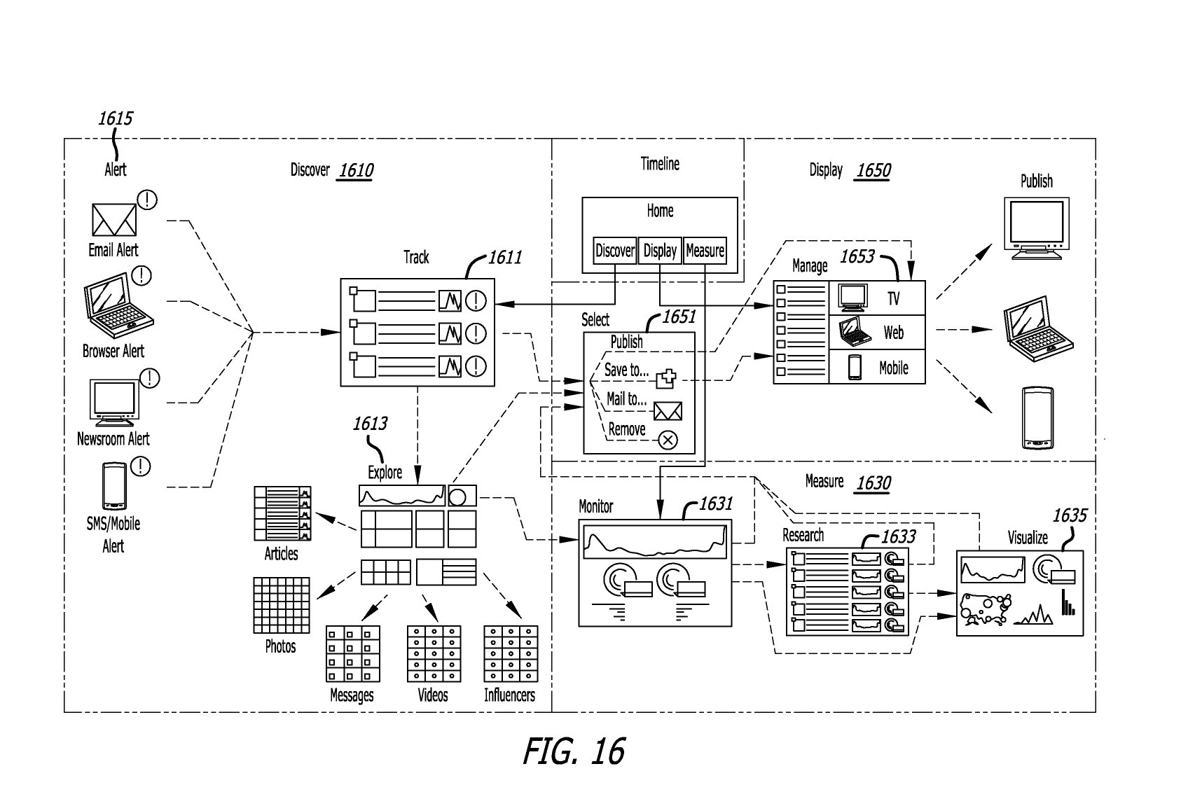

FIG. 16 is an illustration of several features of the various embodiments of a social media processing engine and a data visualization engine and how the features may interact.

In one embodiment, the features may be broken into three major categories, discover 1610, display 1650, and measure 1630. Under the discover 1610 category, there may be a track 1611, explore 1613, and alert 1615 feature. Track 1611 may track subjects of particular interests such as celebrities, disasters, companies, and other identifiable subjects. The subjects being tracked may be preset or client specified. Explore 1613 may retrieve/receive data related to a tracked subject from web traffic such as social media websites, news feeds, forums, and the like. The data may be in the form of articles, photos, messages, videos, influencers, and other suitable data forms. Explore 1613 may conduct high level analytics, such as volume and sentiment on a subject. Explore 1613 may also determine top trending articles, videos, photos; top influencers; and identify important conversations from top influencers.

Track 1611 may trigger an alert 1615 which may alert a user or client about certain information, such as, a spike in activity, publication of negative commentary, new publication, and the like. Alert 1615, when triggered, may send an email alert, browser alert, newsroom alert, a text message/sms/mobile alert, or any other suitable alert.

Under the measure 1630 category, there may be a monitor 1631, research 1633, and/or visualization 1635 feature. Monitor 1631 may analyze data that explore 1631 receives/retrieves to extract or derive information such a sentiment, intent, demographics, quotes, categories, tags, trends, and the like. Monitor 1631 may also provide high level analytics insight into a subject such as volume timeline, total number of message, number of unique messages, top keywords, top hashtags, top NLP entities, and the like. Research 1633 may correlate the data that monitor 1631 extracts and/or derives. Research 1633 may determine a certain demographic that is interested in a topic; top reasons why a product/film/service is liked or disliked; trends, sentiment (which may be based on geography or demographics), and/or other correlations between data points. Research 1633 may conduct deeper demographic breakdowns for a topic and also develop intent predictions. Visualize 1635 may provide a graphic for a client to visualize the correlated data points from research 1633 or any other data from the system.

Under the display 1650 category, there may be a select feature 1651, a manage feature 1653, and a publish feature 1655. Select feature 1651 may allow a client to select outputs from track 1611 and/or explorer 1613, such as alert triggered events, recent articles, photos, messages, videos, or influencers, for saving, e-mailing, publishing or removing. Additionally, clients may be able to select outputs from features in the measure 1630 category also. Manage 1653 may provide a client the ability to pick and choose and/or organize the selections made in Select feature 1651 for publishing. For example, if the client was part of a news network, the client may choose to publish certain data such as images and videos to the news network's television broadcast, and/or other data to its web and/or mobile presence (such as a website or mobile app).

While particular embodiments of the present invention have been described, it is understood that various different modifications within the scope and spirit of the invention are possible. The invention is limited only by the scope of the appended claims.

We claim:

1. A computer implemented method for determining intent of a social media poster comprising:
receiving social media post data;
separating text data from the social media post data;
identifying a username from the social media post data;
creating a profile in a database for the username;
relating the social media post data to a predetermined topic;
processing the text data using a natural language processing engine; and
determining an intent level based on an output of the natural language processing engine.

2. The method of claim 1 wherein relating the post data to a predetermined topic comprises:
identifying predetermined keywords within the text data.

3. The method of claim 1 wherein determining an intent level based on an output of the natural language processing engine further comprises:
updating an intent state in the profile.

4. The method of claim 3 further comprising:
determining a predicted action for an author of the social media post data.

5. The method of claim 4 further comprising:
attaching a confidence level to the predicted action based on a past prediction.

6. The method of claim 5 further comprising:
receiving an additional social media post data from the author indicating an action and confirming the predicted action based on the additional social media post data.

7. the method of claim 6 further comprising:
targeting an ad to the author based on the intent level.

8. A computer implemented method for dynamically creating a new topic comprising:
clustering social media posts related to a first topic;
identifying a cluster with an accelerating share count;
identifying a key word in the cluster; and
creating the new topic using the identified key word.

9. The method of claim 8 wherein clustering social media posts to a first topic further comprises:
determining a first word use frequency for every word in all the social media posts; and
ranking words based on the first word use frequency.

10. The method of claim 9 wherein clustering social media posts to a first topic further comprises:
determining a second word use frequency for every word in the social media posts within a limited time frame;
ranking words based on the first word use frequency and second word use frequency; and
matching an individual post to a highest ranked word used in the individual post.

11. The method of claim 8 wherein clustering social media posts to a first topic further comprises:
determining a use frequency for a word group in all the social media posts.

12. The method of claim 10 wherein a ranking of a word is inversely related to the first word use frequency.

13. The method of claim 8 wherein identifying a cluster with an accelerating share count is determined by:
receiving a first plurality of posts within a first limited time frame;
receiving a second plurality of posts within a second limited time frame;
calculating a first number of individual posts related to the cluster in the first plurality of posts within a first limited time frame;
calculating a second number of individual posts related to the cluster in the second plurality of posts within a first limited time frame; and
calculating the difference between the first number and the second number.

14. The method of claim 13 wherein the second limited time frame is a time period immediately after the first time frame.

15. The method of claim 15 wherein a length of time of the first time frame is equal to a length of time in the second time frame.

16. A computer implemented method for establishing a new keyword for a topic comprising:
having a keyword threshold;
receiving a plurality of individual posts as social media post data;
identifying a noun phrase in the plurality of individual posts;
identifying a predetermined keyword in the plurality of posts;
determining a number of posts in the plurality of posts that have both the noun phrase and predetermined keyword; and
identifying the noun or noun phrase as a keyword when a number of posts using the noun or noun phrase reaches the keyword threshold;
creating a first keyword with the noun or noun phrase.

17. The method of claim 16 wherein the keyword threshold is user adjustable;

18. The method of claim 16 further comprising:
identifying a second plurality of individual posts within the plurality of individual posts that contain the first key word and relating the second plurality of individual posts to the topic.

19. The method of claim 18 wherein the keyword threshold is a measurement of a number of posts containing a word or phrase over a limited period of time.

20. The method of claim 19 wherein the keyword is removed when the number of posts using the noun or noun phrase drops below the threshold.
